(19) United States
(12) Patent Application Publication
(10) Pub. No.: US 2010/0185431 A1
(43) Pub. Date: Jul. 22, 2010

(54) CIRCUIT VERIFICATION DEVICE, METHOD, AND PROGRAM STORAGE MEDIUM

(76) Inventor: Kenji Kokuda, Osaka (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/689,309

(22) Filed: Jan. 19, 2010

(30) Foreign Application Priority Data
Jan. 20, 2009 (JP) 2009-009701

(51) Int. Cl. G06F 17/50

(52) U.S. Cl. 703/14

(57) ABSTRACT

A circuit verification device includes a simulation section and a determination section. The simulation section performs a first simulation using a first net list and a second simulation using a second net list. The first net list includes a size parameter of the pair of transistors and, in the first net list, an instance parameter of a first transistor is specified as +P and an instance parameter of a second transistor is specified as −P, and the second net list includes the same size parameter as in the first net list and, in the second net list, the instance parameter of the first transistor is specified as −P and the instance parameter of the second transistor is specified as +P. The value of P is set at α, which is ½ the control upper limit of mismatch of the threshold voltage between the pair transistors.

### CROSS-REFERENCE TO RELATED APPLICATIONS

This application is based on and claims priority under 35 U.S.C. §119 from Japanese Patent Application No. 2009-009701 filed on Jan. 20, 2009, the disclosure of which is incorporated by reference herein.

### RELATED ART

1. Field of the Invention

The present disclosure relates to a circuit verification device for verifying circuit operation, and to a method and program storage medium of the same.

2. Brief Discussion of Related Art

Conventionally, when designing MOS analogue circuits that include a pair of transistors (pair transistors) in which the consistency of electrical properties therebetween is taken into consideration, such as in a current mirror circuit, a differential amplifier circuit, firstly, the circuit topology (connection state) is decided. Then, optimization and verification is performed on the circuit under conditions that do not take into consideration mismatch (difference) of the threshold voltage between the pair transistors, and thereafter, verification is made on the variation in properties of the circuit occurring due to threshold voltage mismatch between the pair transistors, using a statistical analysis method such as a Monte Carlo method. Explanation of a conventional method will now be given, with reference to the drawings.

FIG. 5 is a flow chart showing the flow of a conventional circuit verification method. First, at step 100, data of a circuit diagram indicating the decided circuit topology is acquired, and a net list is prepared showing the connection state of the circuit indicated by the circuit diagram. At this time, the optimum size of the transistors in the circuit is determined (optimized) in the net list, and corner conditions (process, voltage, temperature, or the like) are further specified as simulation control commands. Circuit simulation is performed by a simulator of the electrical circuit (for example, a Simulation Program with Integrated Circuit Emphasis (SPICE) simulator) based on the net list, and circuit operation is verified. This simulation is performed without taking into consideration mismatch of the threshold voltage between the pair transistors.

At step 102, the simulation result from the electrical circuit simulator is judged. If it is judged that there is a problem with circuit operation (step 102, NG), then the routine returns to step 100, the transistor size is changed, the net list is prepared again, circuit simulation is performed, and circuit operation is verified.

However, if it is judged at step 102 that there would be no problem in circuit operation, at step 104, simulation on the net list which is determined to be no problem at above step 102, is performed a number of times, while changing the threshold voltage using a random number (statistical simulation). Namely, a simulation that takes into consideration the threshold voltage mismatch between the pair transistors is performed for the first time at this stage.

At step 106, judgment is made of the analysis results from the statistical analysis processing of step 104. If it is judged that there would be a problem with circuit operation, the routine returns to step 100, and the above processing is repeated. Namely, the processing from step 100 to step 106 is repeated until determination is made at step 106 that there would be no problem with circuit operation.

A timing analysis method for semiconductor integrated circuits is disclosed in Japanese Patent Application Laid-Open (JP-A) No. 2008-112406. This analysis method also employs Statistical circuit simulation using a Monte Carlo method.

However, when circuit simulation that uses a Monte Carlo method (referred to below as Monte Carlo simulation) is employed as in the statistical analysis method disclosed in JP-A No. 2008-112406, in order to capture the maximum values for variations in the properties of the circuit, it is necessary to execute the Monte Carlo simulation with several thousands of the threshold voltage mismatch conditions. The time required for circuit verification increased accordingly. In addition, when the results of the Monte Carlo simulation are that the design target values have not been attained, this results in returning to optimization and verification procedures for the circuit. Consequently, circuit verification is re-performed in the above manner, resulting in the time required for circuit design increasing. Furthermore, when Monte Carlo simulation with the generation of random numbers is performed for verification, the possibility arises that simulation has not been undertaken in a condition of mismatch of the threshold voltage between the pair transistors which causes variation in circuit properties maximum.

### INTRODUCTION TO THE INVENTION

The present disclosure is made in consideration of the above circumstances and provides a circuit verification device in which the time required for circuit simulation can be reduced, and ensure execution of simulation under condition in which circuit property variation becomes maximum due to mismatch of the threshold voltage. The present disclosure also provides a circuit verification method and a computer readable storage medium storing a circuit verification program that achieves the same.

A first aspect of the present disclosure is a circuit verification device including: a simulation section that, (a) performs a first simulation of circuit operation using a first net list and (b) performs a second simulation of circuit operation using a second net list, wherein the first and second net lists represent the connection state of a circuit including a pair of electrically correlated transistors, the first net list includes a specification of a parameter relating to size of the pair of transistors and, in the first net list, an instance parameter representing a threshold voltage shift amount of a first transistor of the pair of transistors has been specified as +P and an instance parameter of a second transistor of the pair of transistors has been specified as −P, and the second net list includes the same parameter relating to size as in the first net list and, in the second net list, the instance parameter of the first transistor of the pair of transistors has been specified as −P and the instance parameter of the second transistor of the pair of transistors has been specified as +P; and a determination section that determines whether or not the circuit would operate normally by comparing the results of the first simulation and the second simulation of circuit operation against predetermined target values, wherein the value of P is set at α, which is ½ the control upper limit of mismatch of the threshold voltage between the pair transistors.

The control upper limit of the threshold voltage mismatch refers to a permissible value of threshold voltage mismatch that has been predetermined. In the above aspect, by performing simulation of circuit operation under two conditions in which threshold voltage mismatch between the pair transistors are maximum, since circuit simulation that takes into consideration the threshold voltage mismatch can be performed without performing simulation with a statistical analysis method, the overall time required for circuit simulation can be reduced. Furthermore, it can be ensured that simulation of circuit operation is performed in conditions of threshold voltage mismatch in which the variation in circuit properties become maximum.

In the first aspect, the value of P may be set to a value that is a value of α to which a predetermined design margin β has been added.

According to such a configuration, circuit simulation is performed under conditions that are tighter by the design margin. Namely, in this aspect, circuit simulation can be performed that takes into consideration the threshold voltage mismatch without performing simulation with a statistical analysis method, by performing simulation of circuit operation under two conditions of maximum threshold voltage mismatch between the pair transistors in a state in which the design margin has been incorporated. Hence the overall time required for circuit simulation can be reduced. Furthermore, it can be ensured that simulation of circuit operation is performed in conditions of threshold voltage mismatch in which the variation in circuit properties in a state incorporating the design margin become maximum.

A second aspect of the present disclosure is a computer readable storage medium stored with a program for causing a computer to operate as the execute circuit verification device of the first aspect.

A third aspect of the present disclosure is method of operating the circuit verification device of the first aspect.

### BRIEF DESCRIPTION OF THE DRAWINGS

Exemplary embodiments of the present disclosure will be described in detail based on the following figures, wherein:

FIG. 1 is a diagram showing an outline of a hardware configuration of a computer functioning as a circuit verification device according to an exemplary embodiment;

FIG. 2 is a block diagram showing a functional configuration of a circuit verification device realized by the hardware resources shown in FIG. 1;

FIG. 3 is a flow chart showing a flow of circuit operation verification executed in a circuit verification device;

FIG. 4A is an example of a circuit diagram of an operational amplifier, and FIG. 4B shows a portion of a net list for use in SPICE simulation prepared based on the circuit diagram of FIG. 4A, in which descriptions relating to MOS transistors M1 and M2 configuring pair transistors of a differential input section of the operational amplifier are extracted; and

FIG. 5 is a flow chart showing the flow of a conventional circuit verification method.

### DETAILED DESCRIPTION

The exemplary embodiments of the present disclosure are described and illustrated below to encompass a circuit verification device for verifying circuit operation, and to a method and program storage medium of the same. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

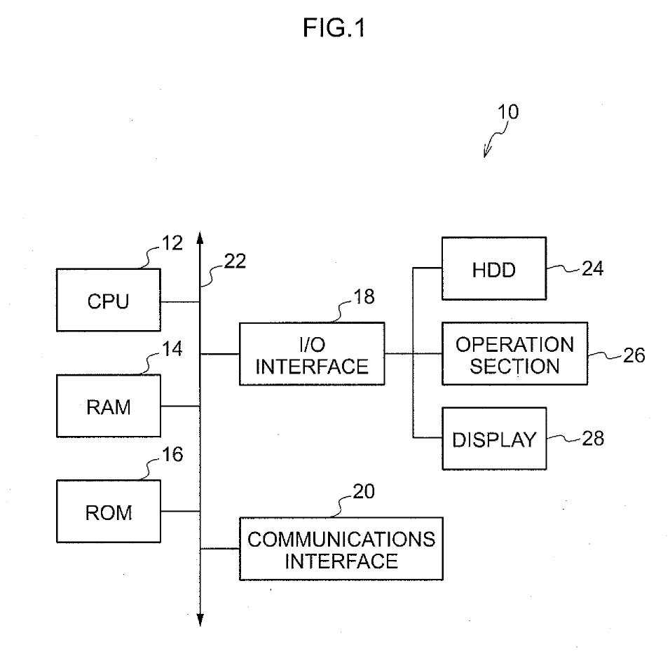

FIG. 1 is a diagram showing an outline of a hardware configuration of a computer functioning as a circuit verification device according to the exemplary embodiment. This computer will be referred to below as circuit verification device 10.

The circuit verification device 10 is equipped with a Central Processing Unit (CPU) 12, a Random Access Memory (RAM) 14, a Read Only Memory (ROM) 16, an Input/Output (I/O) interface 18, and a communications interface 20, and these are mutually connected to each other through a bus 22.

The I/O interface 18 is connected to a Hard Disk Drive (HDD) 24, an operation section 26, and a display 28. The HDD 24 can read data from and write data to an internally installed hard disk. The operation section 26 is equipped with a keyboard, a mouse, or the like. Various data and commands are input to the circuit verification device 10 by operations of a user thereon. The display 28 may be a liquid crystal display, a CRT display, or the like, and the display 28 displays data, such as images, under instruction from the CPU 12.

The communications interface 20 is connected to a network, such as a communications circuit, or a LAN. The circuit verification device 10 exchanges data with other terminals connected to the network, via the communications interface 20.

The CPU 12 executes a program stored in the ROM 16, the HDD 24, or the like. The RAM 14 is used as a storage section for temporarily storing data that has been input from another terminal via the communications interface 20, or data that has been input by operation of a user, and is also used as a working memory when programs of the CPU 12 are executed.

Note that storage media for storing programs for execution by the CPU 12 are not limited to the above ROM 16, HDD 24 or the like, and a CD-ROM drive, FD drive or the like may be used. For example, while not illustrated in the drawings, a portable storage medium, such as a DVD disk, magneto-optical disk, IC card, or the like, or a storage device such as a HDD or the like, provided externally to the circuit verification device 10 may be used. Furthermore, the storage media may be a database connected through the network, another computer system or database thereof, or even a transmission medium such as carrier waves transmitted through an electrical communication line.

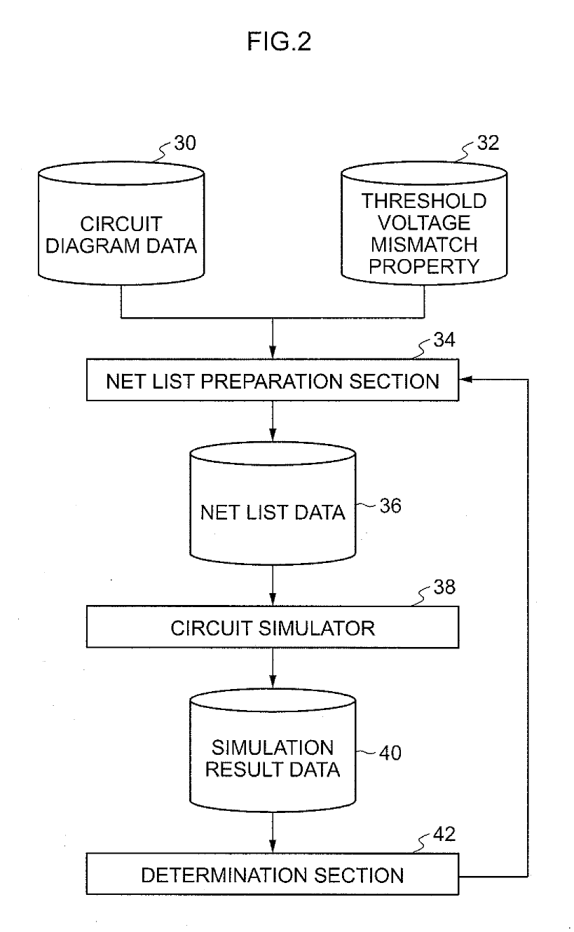

FIG. 2 is a block diagram showing a functional configuration of a circuit verification device 10 which can be embodied by the hardware resources shown in FIG. 1.

As shown in FIG. 2, the circuit verification device 10 includes a circuit diagram storage section 30, a threshold voltage mismatch property storage section 32, a net list preparation section 34, a net list storage section 36, a circuit simulator 38, a simulation result storage section 40, and a determination section 42.

The circuit diagram storage section 30, the threshold voltage mismatch property storage section 32, the net list storage section 36 and the simulation result storage section 40 are, for example, configured by the RAM 14, the HDD 24, or the like. The net list preparation section 34, the circuit simulator 38, and the determination section 42 are functions realized by the CPU 12 executing a program stored on the ROM 16, the HDD 24, or the like.

Data representing a circuit diagram (circuit diagram data) is stored in the circuit diagram storage section 30. This data may be, for example, CAD data of electrical circuits prepared using a Computer Aided Design (CAD) system.

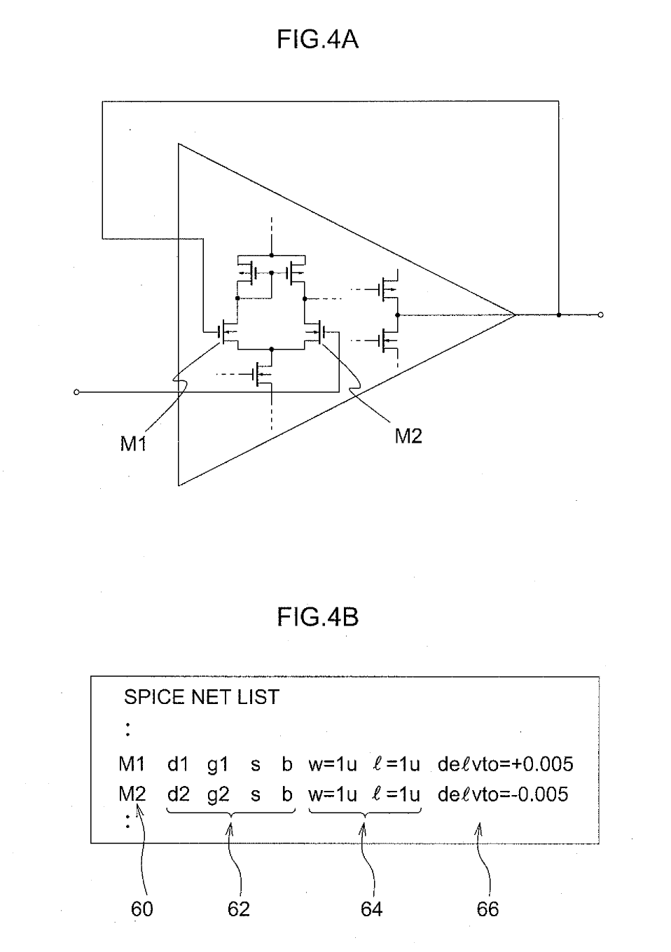

The threshold voltage mismatch property storage section 32 stores data showing a control upper limit of the threshold voltage mismatch (difference) of pair transistors which are included in the circuits represented by the circuit diagram data stored in the circuit diagram storage section 30. The pair transistors are electrically correlated pairs of transistors which are used for current mirror circuits, differential amplifier circuits, and the like (see FIG. 4A). Since the overall circuit will be affected by a mismatch in the electrical properties of the pair transistors, the electrical matching of the pair transistors should be considered.

The control upper limit of the threshold voltage mismatch is a predetermined permissible value for variation in threshold voltages. The control upper limit may be included, for example, in wafer process control data, and being extracted from the wafer process control data in advance, and stored in the threshold voltage mismatch property storage section 32. The wafer process control data is specified in advance as a test standard for wafer processing in a factory.

The net list preparation section 34 prepares the net list based on the circuit diagram data stored in the circuit diagram storage section 30, and the control upper limit of the threshold voltage mismatch stored in the threshold voltage mismatch property storage section 32. The net list is data representing the connection states of the circuit to be subjected to simulation (see also FIG. 4B).

The data of the net list prepared in the net list preparation section 34 is stored in the net list storage section 36.

The circuit simulator 38 performs circuit simulation based on the net list data stored in the net list storage section 36. For example, SPICE simulator, which is well known as software for operation verification of electrical circuits, may be used as the circuit simulator 38.

The simulation result storage section 40 stores data of the results of circuit simulation performed by the circuit simulator 38.

The determination section 42 determines whether or not the circuit represented by the data stored in the circuit diagram storage section 30 would undertake normal operation, by comparing the data of the results of circuit simulation stored in the simulation result storage section 40 with predetermined target values.

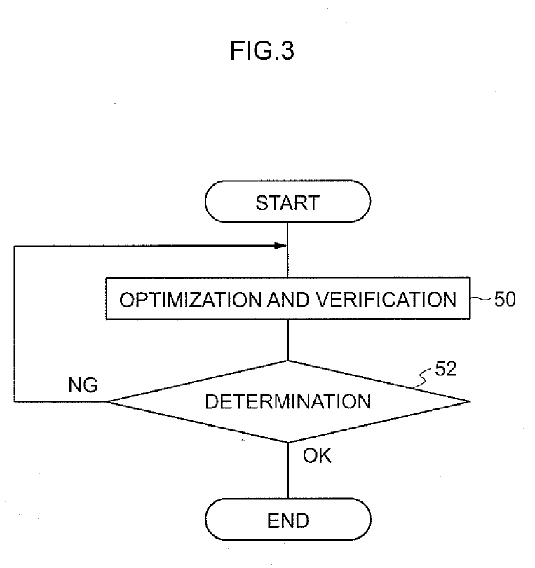

FIG. 3 is a flow chart showing a flow of circuit operation verification executed in the circuit verification device 10.

First, at step 50, the net list preparation section 34 acquires the circuit diagram data stored in the circuit diagram storage section 30, and prepares the net list based on this circuit diagram data. In the exemplary embodiment, the circuits of the circuit data subjected to net list preparation in the circuit diagram data are MOS analogue circuits that include pair transistors, such as current mirror circuits, differential input circuits, and the like.

In the net list, the optimum theoretical size of transistors included in the circuits of the circuit diagram is specified (optimization), and, in addition, the corner conditions (process, voltage, temperature, and the like) are specified as simulation control commands. The net list preparation section 34 also prepares a net list that includes specification of an instance parameter (delvto) indicating the threshold voltage shift amount of pair transistors in the transistors included in the above circuit. In the circuit simulation, the threshold voltages of the transistors are shifted by the amount specified by delvto.

Specifically, if ½ of the control upper limit of the threshold voltage mismatch of pair transistors is α, then a net list is prepared with one of the pair transistors specified with delvto=+α, and the other of the pair transistors is specified with delvto=−α as the specified net list (i.e., the instance parameters of the pair transistors are respectively set to value P having opposite signs, and the value of P is set to α which is ½ of the control upper limit of the threshold voltage mismatch of pair transistors). This net list prepared is referred to as the first net list.

For transistors that are not pair transistors, either delvto is not specified (not listed in the net list) or delvto is specified as 0.

FIG. 4A is an example of a circuit diagram of an operational amplifier, and FIG. 4B shows a portion of a net list for use in SPICE simulation which is prepared based on the circuit diagram of FIG. 4A, in which descriptions relating to MOS transistors M1 and M2 configuring pair transistors of a differential input section of the operational amplifier are extracted.

As shown in FIG. 4B, the MOS transistors M1 and M2 are defined as component names 60. Next, node numbers 62 of each of the terminals are specified in order to determine the connection state of the MOS transistors M1 and M2. For MOS transistor M1, a drain terminal node number d1, a gate terminal node number g1, a source terminal node number s, and a bulk terminal node number b are specified in this sequence from the left. For MOS transistor M2, drain terminal node number d2, a gate terminal node number g2, a source terminal node number s, and a bulk terminal node number b are specified in this sequence from the left.

Subsequently, a device model parameter 64 for determining the size of the MOS transistors M1 and M2 is specified. Here, for both MOS transistors M1 and M2, the gate width w is specified as 1u, and the gate length 1 is specified as 1u (u here indicates microns(μ)).

After this, an instance parameter delvto 66 is specified. Here, delvto of MOS transistor M1 is specified as “+0.005” and delvto of MOS transistor M2 is specified as “−0.005”. Namely, in this example, the control upper limit indicated of the threshold voltage mismatch of the pair transistors is 0.01V.

By specifying the instance parameter delvto in this manner, a first net list is prepared under first conditions of maximum threshold voltage mismatch between the pair transistors.

Furthermore, the net list preparation section 34 prepares a net list in which the delvto is specified with the opposite sign to that of the first net list, without changing the parameters relating to the size of the pair transistors. Namely, a net list is prepared with the delvto of the first of the pair transistors specified as −α and the delvto of the second of the pair transistors is specified as +α. This net list is referred to as the second net list.

When the first net list is the net list shown in FIG. 4B, the portions describing the MOS transistors M1 and M2 of the second net list are as shown below.

| | | | | | |
|---|---|---|---|---|---|
| M1 | d1 | g1 | s | b | w = lu 1 = 1u delvto = −0.005 |
| M2 | d2 | g2 | s | b | w = lu 1 = 1u delvto = +0.005 |

Thus, in the second net list, the instance parameter delvto of the MOS transistor M1 is specified as “−0.005”, and the instance parameter delvto of the MOS transistor M2 is specified as “+0.005”. Other parts are the same as those of the first net list.

The second net list is prepared in this manner by specifying the instance parameter delvto under second conditions in which threshold voltage mismatch between the pair transistors is maximum.

At step 50, data for the first net list and data for the second net list that prepared by the net list preparation section 34 is stored in the net list storage section 36.

The circuit simulator 38 performs simulation of circuit operation for the first time, employing the first net list stored in the net list storage section 36, and verifies the circuit operation. The data of the simulation results is stored in the simulation result storage section 40. Next, the circuit simulator 38 performs simulation of circuit operation for the second time, employing the second net list stored in the net list storage section 36, and verifies the circuit operation. Data of the results of the simulation is also stored in the simulation result storage section 40.

In this manner, in step 50, the two net lists are prepared corresponding to each of the respective conditions of maximum threshold voltage mismatch between the pair transistors, and circuit simulation is performed two times.

Next, in step 52, determination is made as to whether or not the circuit would operate normally (i.e., would perform pre-defined operation), by comparing the data stored in the simulation result storage section 40, of the results of simulation performed by the circuit simulator 38 the first time and the second time, with predetermined target values. If the data of the results of simulation does not attain the target values (step 52, NG), it is determination that there is a problem with circuit operation and the routine returns to step 50, optimization is performed by changing the size of the transistors, two net lists are re-prepared as described above with the instance parameter delvto of the pair transistors specified as above, and circuit simulations are performed thereon.

However, at step 52, when the determination section 42 determines that the simulation result has attained the target values, and it is determined that there is no problem with circuit operation (step 52, OK), processing of the current flow chart is ended.

In the above manner, according to the exemplary embodiment, by employing circuit simulation using net lists specified so that the threshold voltage mismatch between the pair transistors is at a maximum, conventionally executed verification of variation in properties of circuits employing statistical analysis methods becomes unnecessary, and the time required for circuit simulation can be reduced.

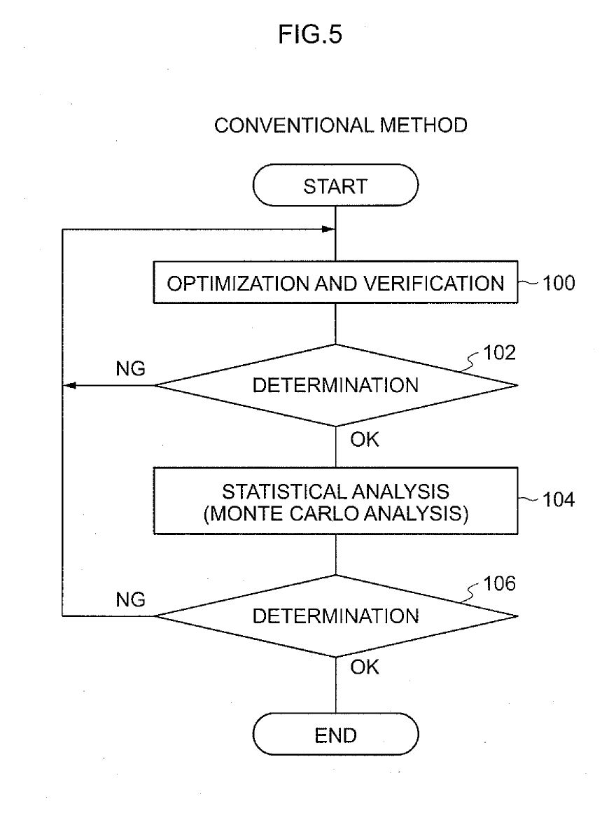

By applying the exemplary embodiment, optimization and verification of a circuit after circuit topology determination (step 100 of FIG. 5) that takes 5 days and Monte Carlo simulation (step 104 of FIG. 5) that takes 0.5 days with conventional circuit design methods, can be expected to be reduced by the 0.5 days, which are required for Monte Carlo simulation. Furthermore, if the results of Monte Carlo simulation were that the design target values were not attained and the procedure needed to be returned to the circuit optimization and verification step, then a maximum reduction of design period of 6 days can be expected.

Furthermore, there is a possibility that threshold voltage mismatch conditions for the maximum values of variation in circuit properties may not be covered when Monte Carlo simulation with the generation of random numbers is applied as in a convention method. However, when the simulation is performed utilizing the net lists in which the instance parameter delvto have been specified as explained in the exemplary embodiment, it is ensured that simulation can be performed while covering these conditions.

Note that the present invention is not limited to the above described exemplary embodiment, and various changes and modifications may be made to the design with in a scope of the invention recited in the claims.

For example, while explanation was given in the exemplary embodiment of an example in which the net list preparation section 34 prepared the net list, embodiments are not limited to this and a user may create the net list based on the circuit diagram. Moreover, a net list in which the instance parameter delvto is not specified may be automatically prepared by the net list preparation section 34, and then a user may add in the instance parameter delvto to the net list by manual input.

Furthermore, although explanation was given in the above exemplary embodiment with respect to a MOS analogue circuit including pair transistors, such as current mirror circuits, differential input circuits or the like, embodiments are not limited thereto. Embodiments may be applicable to the design of various circuits where output circuits of the same topology exist in an LSI chip, and it is necessary to suppress differences in the electrical properties between output circuits, as in display driver LSI's. Since there is also an effect on the display state from mismatches of the respective electrical properties in the respective transistors between such output circuits, there is a requirement to consider electrical mismatch.

A circuit verification can be made when there are three or more electrically correlated transistors present as described below. First, two of the plural transistors are extracted and treated as the pair of transistors described above, a net list is prepared in which the delvto is specified in the same manner as in the above exemplary embodiment, and for the remaining transistor(s), two net lists are prepared in which either delvto is not specified, or delvto is specified as 0. Then, as above, circuit simulation is performed two times using the two net lists as described above, and then determination of circuit operation is made. This is performed for all combinations of the electrically correlated transistors.

Furthermore, explanation has been given above of a case where, when ½ of the control upper limit of the threshold voltage mismatch of pair transistors is α, a first net list is prepared with one of the pair transistors specified with delvto=+α and the other of the pair transistors specified with delvto=−α, and a second net list is prepared with the first of the pair transistors specified with delvto=−α and the second of the pair transistors specified with delvto=+α. However, circuit simulation may be performed under more exacting conditions than the above, with the delvto specified as a value that includes a design margin for maintaining the manufacturing variability incorporated in the values.

Specifically, the net lists may be prepared by specifying the parameters related to the size of the pair transistors and other transistors incorporated in the circuit, as described above, preparing a first net list with one of the pair transistors specified with delvto=+(α+β), and the other of the pair transistors specified with delvto=−(α+β), and preparing a second net list with the first of the pair transistors specified with delvto=−(α+β), and the second of the pair transistors specified with delvto=+(α+β), where α is ½ of the control upper limit of the threshold voltage mismatch of pair transistors, and β is a predetermined design margin.

Simulation of circuit operation is then performed for the first time using the first net list, and for the second time using the second net list.

By thus specifying the instance parameter delvto, simulations are performed using the first net list and the second net list for the maximum conditions of threshold voltage mismatch between the pair transistors while taking into consideration the design margin. Since circuit simulation can be performed that takes into consideration the threshold voltage mismatch in a state in which the design margin has been incorporated, the overall time required for circuit simulation can be contracted. Moreover, it can be ensured that simulation of circuit operation is performed in conditions of threshold voltage mismatch in which the circuit property variation is maximum, and taking into consideration the design margin.

According to the embodiments as explained above, the time required for circuit simulation can be reduces, with certainty that simulation is executed under the threshold voltage mismatch conditions in which circuit property variation is maximum due to the threshold voltage mismatch.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A circuit verification device comprising:
a simulation section that, (a) performs a first simulation of circuit operation using a first net list and (b) performs a second simulation of circuit operation using a second net list, wherein the first and second net lists represent the connection state of a circuit including a pair of electrically correlated transistors, the first net list includes a specification of a parameter relating to size of the pair of transistors and, in the first net list, an instance parameter representing a threshold voltage shift amount of a first transistor of the pair of transistors has been specified as +P and an instance parameter of a second transistor of the pair of transistors has been specified as −P, and the second net list includes the same parameter relating to size as in the first net list and, in the second net list, the instance parameter of the first transistor of the pair of transistors has been specified as −P and the instance parameter of the second transistor of the pair of transistors has been specified as +P; and
a determination section that determines whether or not the circuit would operate normally by comparing the results of the first simulation and the second simulation of circuit operation against predetermined target values,
wherein the value of P is set at α, which is ½ the control upper limit of mismatch of the threshold voltage between the pair transistors.

2. The circuit verification device of claim 1, wherein the value of P is set to a value that is a value of α to which a predetermined design margin β has been added.

3. A computer readable storage medium storing a program for causing a computer to execute circuit verification processing, the circuit verification processing comprising:
preparing a first net list representing the connection state of a circuit including a pair of electrically correlated transistors, including a specification of a parameter relating to size of the pair of transistors, and in which an instance parameter representing a threshold voltage shift amount of a first transistor of the pair of transistors is specified as +P and the instance parameter of a second transistor of the pair of transistors is specified as −P;
performing a first simulation of circuit operation using the first net list;
preparing a second net list including the same parameter relating to size as in the first net list, and in which the instance parameter of the first transistor of the pair of transistors is specified as −P and the instance parameter of the second of the pair of transistors is specified as +P;
performing a second simulation of circuit operation using the second net list; and
comparing the results of the first simulation and the second simulation of circuit operation against predetermined target values and determining whether or not the circuit would operate normally,
wherein the value of P is set at α, which is ½ the control upper limit of mismatch of the threshold voltage between the pair transistors.

4. The storage medium of claim 3, wherein the value of P is set to a value that is a value of α to which a predetermined design margin β has been added.

5. A circuit verification method comprising:
preparing a first net list representing the connection state of a circuit including a pair of electrically correlated transistors, including a specification of a parameter relating to size of the pair of transistors, and in which an instance parameter representing a threshold voltage shift amount of a first transistor of the pair of transistors is specified as +P and the instance parameter of a second transistor of the pair of transistors is specified as −P;
performing a first simulation of circuit operation using the first net list;
preparing a second net list including the same parameter relating to size as in the first net list, and in which the instance parameter of the first transistor of the pair of transistors is specified as −P and the instance parameter of the second of the pair of transistors is specified as +P;
performing a second simulation of circuit operation using the second net list; and
comparing the results of the first simulation and the second simulation of circuit operation against predetermined target values and determining whether or not the circuit would operate normally,
wherein the value of P is set at α, which is ½ the control upper limit of mismatch of the threshold voltage between the pair transistors.

6. The circuit verification method of claim 5, wherein the value of P is set to a value that is a value of α to which a predetermined design margin β has been added.
